(19) United States
(12) Patent Application Publication
(10) Pub. No.: US 2009/0047183 A1
(43) Pub. Date: Feb. 19, 2009

(54) AIR CLEANERS WITH ADAPTIVE OZONE GAS GENERATION

(75) Inventors: Chiu-Yuan Lin, Taipei (TW); Chien-Pang Hung, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEYOND INNOVATION TECHNOLOGY CO., LTD., Taipei (TW)

(21) Appl. No.: 12/107,891

(22) Filed: Apr. 23, 2008

(30) Foreign Application Priority Data
Aug. 15, 2007 (TW) 96130126

(51) Int. Cl. G05D 99/00

(52) U.S. Cl. 422/105

(57) ABSTRACT

An air cleaner is provided, comprising a control unit, an inverter, a negative ion generator, and an ozone gas generator. The control unit generates a control signal. The inverter coupled to the control unit generates a voltage according to the control signal. The negative ion generator coupled to the inverter receives the voltage to generate a negative ion. The ozone gas generator coupled to the inverter receives the voltage to generate an ozone gas. The negative ion generator and the ozone generator are both activated when the voltage is larger than a first voltage level, and the negative ion generator is activated and the ozone gas generator is deactivated when the voltage is less than the first voltage level and larger than a second voltage level.

### BACKGROUND OF THE INVENTION

1. Field of the Invention

The invention relates to an air cleaner, and more particularly to air cleaners where a negative ion generator and an ozone gas generator share a common inverter.

2. Description of the Related Art

Due to consistent pollution in modern cities, more and more illnesses related to poor air quality occur while in indoor settings. Thus, air cleaners are used to filter out harmful substances and provide clean indoor air.

Conventional air cleaners can generate negative ions and ozone gas. The negative ions can absorb air particles (e.g. pollen, dust, cigarette smoke) and then fall to the ground. An ozone molecule composed of three oxygen atoms is a strong oxidant and can oxidize various odorous gases to eliminate unpleasant odors, and the ozone gas converts to oxygen gas after the chemical reaction. Furthermore, a high concentration of the ozone gas can be used as a bactericide; however, the ozone gas is a strong stimulus to the respiratory tract of human beings and can cause difficulty of breathing, chest pains, coughing, or throat pains. Consequently, the air cleaner is required to generate the negative ions and deactivate the generation of the ozone gas when someone is inside the enclosed area encompassing the air cleaner.

FIG. 1 is architecture of a conventional air cleaner 100. The air cleaner 100 comprises a control unit 102 used to control a negative ion generator 104 and an ozone gas generator 106. The negative ion generator 104 is composed of a boost circuit and a point discharge electrode. The boost circuit can convert an alternative current (AC) voltage to an extremely high negative voltage and then output it to the point discharge electrode. The point discharge electrode is an open loop circuit capable of ionizing surrounding air as negative ions. The ozone gas generator 106 is composed of two electrodes, and a high direct current (DC) voltage difference applied to the electrodes can induce a current to flow between the two electrodes. An arc is generated to convert the oxygen gas of surrounding air to the ozone gas when the current rises to a predetermined level. The electrodes of the ozone gas generator 106, however, cannot receive the high DC voltage for a long period of time, so an AC voltage is needed to intermittently drive the electrodes to generate the ozone gas.

Accordingly, both the negative ion generator 104 and the ozone gas generator 106 are required to be driven by the AC voltage. Because the ozone gas is harmful for human beings, the ozone gas must be generated when no one is inside the enclosed area of the air cleaner. The negative ions, however, are required to be continuously generated when the air cleaner is activated, so the negative ion generator 104 and the ozone gas generator 106 must be driven separately. Referring to FIG. 1, the negative ion generator 104 is driven by an inverter 108, while the ozone gas generator 106 is driven by an inverter 110. The inverters 108 and 110 can be respectively controlled by the control unit 102 to provide AC voltages of different amplitudes. When someone is inside the enclosed area of the air cleaner, the control unit 102 can deactivate the inverter 110 to stop the ozone gas generator 106 from generating the ozone gas. Meanwhile, the control unit 102 still activates the inverter 108 to output the AC voltage to the negative ion generator 104 to continue to generate the negative ions.

The use of the two inverters not only results in high production costs but also requires large circuit area, so that it is difficult to reduce the size of the air cleaner. Therefore, an unaddressed need exists in the art to address the aforementioned deficiencies and inadequacies.

### BRIEF SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The invention provides an air cleaner capable of providing an inverter shared by a negative ion generator and an ozone gas generator in a Burst Mode. The air cleaner comprises a control unit, an inverter, a negative ion generator, and an ozone gas generator. The control unit generates a control signal. The inverter coupled to the control unit generates a voltage according to the control signal. The negative ion generator coupled to the inverter receives the voltage to generate a negative ion. The ozone gas generator coupled to the inverter receives the voltage to generate an ozone gas. The negative ion generator and the ozone generator are both activated when the voltage is larger than a first voltage level, and the negative ion generator is activated and the ozone gas generator is deactivated when the voltage is less than the first voltage level and larger than a second voltage level.

The invention provides an air cleaner capable of providing an inverter shared by a negative ion generator and an ozone gas generator in a DC Mode. The air cleaner comprises a control unit, an inverter, a negative ion generator, an ozone gas generator, and a control circuit. The control unit generates a switch signal. The inverter coupled to the control unit receives a feedback signal with a predetermined voltage level to generate a voltage. The negative ion generator coupled to the inverter receives the voltage to generate a negative ion. The ozone gas generator coupled to the inverter receives the voltage to induce a current for generating an ozone gas. The control circuit coupled to the control unit, the inverter, and the ozone gas generator, receives the switch signal to generate the feedback signal. The feedback signal is increased to reduce the voltage when the negative ion generator is to be activated and the ozone gas generator is to be deactivated, thereby enabling the feedback signal to return to the predetermined voltage level.

### BRIEF DESCRIPTION OF THE DRAWINGS

The invention can be more fully understood by reading the subsequent detailed description and examples with references made to the accompanying drawings, wherein:

FIG. 1 is architecture of a conventional air cleaner 100;

FIG. 2 is a block diagram of an air cleaner 200 according to an embodiment of the invention;

FIG. 3 is the circuitry of the air cleaner 200;

FIG. 4 is a block diagram of an air cleaner 400 according to another embodiment of the invention; and

FIG. 5 is the circuitry of the air cleaner 400.

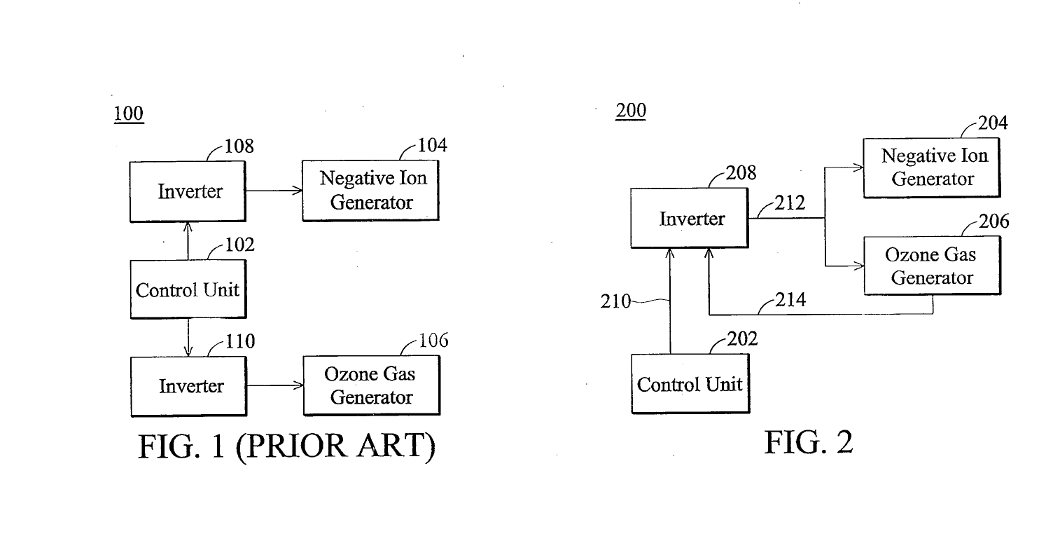

### DETAILED DESCRIPTION OF THE INVENTION

FIG. 2 is a block diagram of an air cleaner 200 according to an embodiment of the invention. The air cleaner 200 uses a control signal to control the generation of the ozone gas in a Burst Mode. A control unit 202 outputs a control signal 210 to control the generation of the ozone gas, and the control signal 210 is a pulse width modulation (PWM) signal.

The air cleaner 200 comprises a control unit 202, a negative ion generator 204, an ozone gas generator 206, and an inverter 208. The inverter 208 is coupled to the control unit 202, and can output an AC voltage 212 according to the control signal 210. The negative ion generator 204 is coupled to the inverter 208, and can receive the AC voltage 212 to generate negative ions. The ozone gas generator 206 is also coupled to the inverter 208, and can generate a current according to the AC voltage 212 to induce an arc to generate the ozone gas. It is noted that the current generated by the ozone gas generator 206 can be converted to a feedback signal 214 and then input into the inverter 208.

Generally, the threshold voltage enabling the ozone gas generator 206 to generate the ozone gas is higher than the threshold voltage enabling the negative ion generator 204 to generate the negative ions. Accordingly, when someone enters an enclosed area encompassing the air cleaner and the ozone gas generator 206 is required to be deactivated, the control unit 202 can output a higher than a predetermined duty cycle control signal 210 to the inverter 208, and then the inverter 208 can output the AC voltage 212 with an amplitude lower than the threshold voltage of the generation of the ozone gas and higher than the threshold of the generation of the negative ions. Therefore, the control unit 208 can individually deactivate the ozone gas generator 206 while still activating the negative ion generator 204. An advantage of the air cleaner 200 is that only one inverter is required to provide the AC voltage to the negative ion generator and the ozone gas generator.

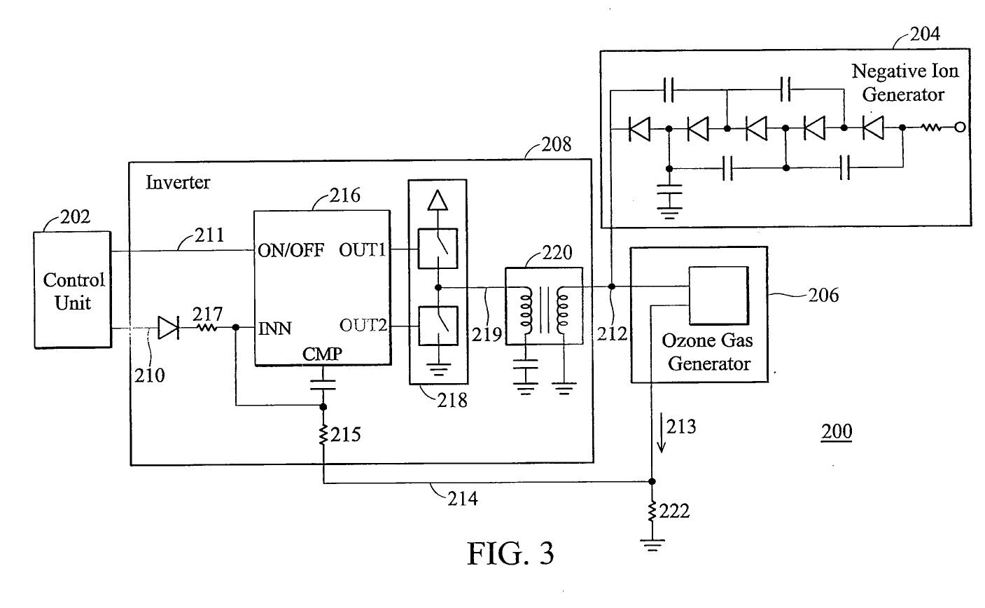

FIG. 3 is the circuitry of the air cleaner 200. The inverter 208 comprises a pulse width modulator 216, a switch device 218, and a transformer 220. The pulse width modulator 216 can output a driving signal (e.g. the output of output ports OUT1 and OUT2) to drive the switch device 218 according to the control signal 210 and the feedback signal 214. The driving signals output by the output ports OUT1 and OUT2 are PWM signals and inverted with each other. The switch device 218 is coupled to the pulse width modulator 216 and a supply voltage Vc, and can output a PWM signal 219 according to the driving signal. The switch device 218 in the embodiment can be a half-bridge switch, a full-bridge switch, or other topologies known in the art.

The transformer 220 has a primary side coupled to the switch device 218 and a secondary side coupled to the negative ion generator 204 and the ozone gas generator 206. The transformer 220 can convert the PWM signal 219 to the AC voltage 212 with a high amplitude, and the amplitude of the AC voltage 212 can be increased with the increase of the duty cycle of the PWM signal 219.

The negative ion generator 204 is coupled to the transformer 220, and comprises a boost circuit capable of increasing the voltage 212 to an extremely high negative voltage to generate the negative ions. The ozone gas generator 206 is also coupled to the transformer 220, and comprises two electrodes used to generate a current 213 according to the AC voltage 212. The ozone generator 206 starts to generate the ozone gas when the current 213 is larger than a threshold value (i.e. the voltage 212 is larger than a voltage level). The current 213 can be converted to the feedback signal 214 by a resistor 222. The pulse width modulator 216 can output the driving signal according to the control signal 210 and the feedback signal 214.

In the embodiment of FIG. 3, the pulse width modulator is controlled by negative feedback, so for stable operation, a predetermined voltage level requires the sum of the PWM signal 210 and the feedback signal 214. When the sum is increased, the inverter 208 can reduce the AC voltage 212 to stop the ozone gas generator 206 from generating the ozone gas and reduce the feedback signal 214 to force the sum to return to the predetermined voltage level. On the contrary, when the sum is decreased, the inverter 208 can increase the AC voltage 212 to enable generation of the ozone gas and increase the feedback signal 214 to force the AC voltage 212 to return to the predetermined voltage level. It is noted that the frequency of the PWM signal 219 is higher than that of the control signal 210. In one embodiment, the control unit 202 can be a micro control unit (MCU), and the control unit 202 can output an ON/OFF signal 211 to the pulse width modulator 216 to activate or deactivate the negative ion generator 204 and the ozone gas generator 206.

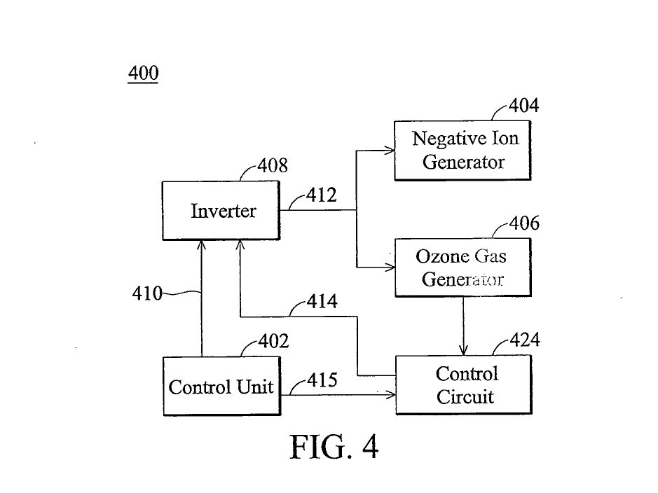

FIG. 4 is another embodiment of block diagram of air cleaner 400. In the embodiment, the air cleaner 400 controls the generation of the ozone gas in a DC mode. The air cleaner 400 comprises a control unit 402, a negative ion generator 404, an ozone gas generator 406, an inverter 408, and a control circuit 424. The inverter 408 is coupled to the control unit 402 and the control circuit 424, and can generate an AC voltage 412 according to a DC voltage 410 output by the control unit 402 and a feedback signal 414 output by the control circuit 424. The DC voltage 410 controls the concentration of the ozone gas generated by the ozone gas generator 406. The concentration of the ozone gas decreases with the increase of the DC voltage 410. The negative ion generator 404 is coupled to the inverter 408, and can receive the AC voltage 412 to generate the negative ions. The ozone gas generator 406 is also coupled to the inverter 408, and can receive the AC voltage 412 to generate the ozone gas. The current generated by the ozone gas generator 406 can be converted to the feedback signal 414 by the control circuit 424 and then output to the inverter 408.

The sum of the feedback signal 414 and the DC voltage 410 has a predetermined voltage level. The feedback signal 414 is unchanged when the DC voltage 410 is fixed. For example, when someone enters an enclosed area encompassing the air cleaner and the ozone gas generator 406 is required to be deactivated, the control unit 402 can output a switch signal 415 to the control circuit 424 to increase the feedback signal 414, thereby increasing the sum of the feedback signal 414 and the DC voltage 410. Meanwhile, the inverter 408 reduces the AC voltage 412 to reduce the feedback signal 414, thereby forcing the feedback signal 414 to return to its original voltage level. The amount of decrease of the AC voltage 412 can be controlled by the internal circuit of the control circuit 424, and therefore the AC voltage 412 generated by the inverter 408 can be controlled between the threshold voltage of the generation of the ozone gas and the threshold voltage of the generation of the negative ions. Consequently, the negative ion generator 404 can be activated while the ozone gas generator 406 is deactivated, and further share the same inverter 408 as the ozone gas generator 406.

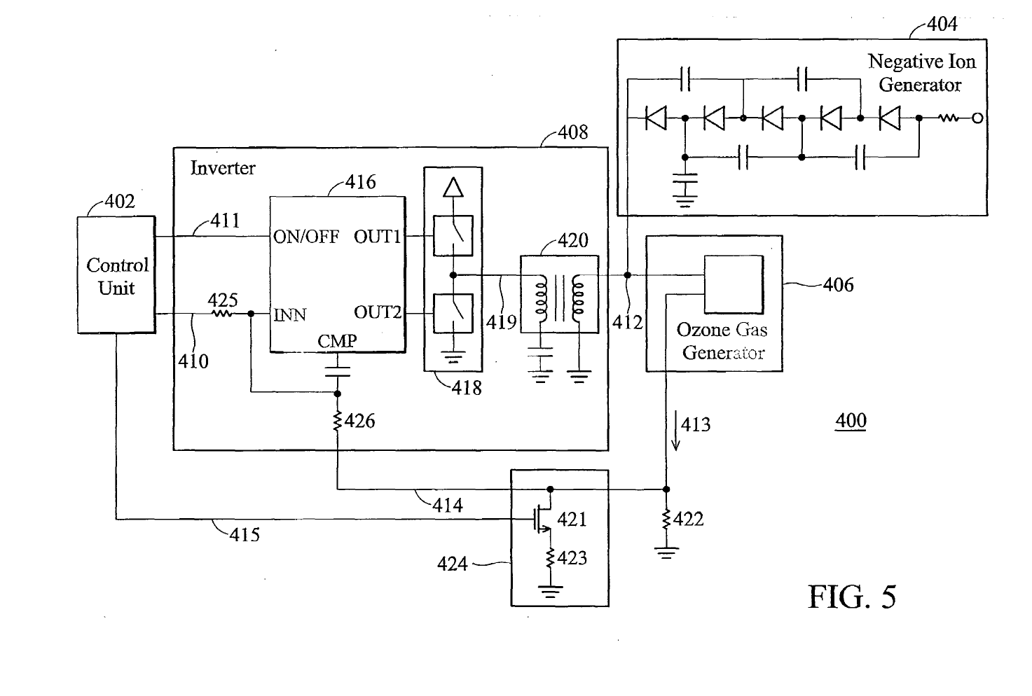

FIG. 5 is the circuitry of the air cleaner 400. The inverter 408 comprises a pulse width modulator 416, a switch device 418, and a transformer 420. The pulse width modulator 416 can output a driving signal according to the sum of the DC voltage 410 and the feedback signal 414. The switch device 418 can output a PWM signal 419 according to the driving signal. The primary side of the transformer 420 is coupled to the switch device 418, and the secondary side of the transformer 420 is coupled to the negative ion generator 404 and the ozone gas generator 406. The transformer 420 can convert the PWM signal 419 to the AC voltage 412 with high amplitude. The amplitude of the AC voltage 412 is proportional to the duty cycle of the PWM signal 419.

The function of the negative ion generator 404 and the ozone gas generator 406 are respectively the same as the negative ion generator 204 and the ozone gas generator 206, thus they will not be described hereafter for brevity. The control circuit 424 comprises a switch 421 and a resistor 423. The switch 421 can be a transistor.

When no one is inside the enclosed area encompassing the air cleaner and the ozone gas generator 406 is required to be activated, the control unit 402 can output the switch signal 415 to turn on the switch 421, and the feedback signal 414 can be the resistance of a parallel connection of the resistors 422 and 423 multiplied by the current 413. On the contrary, when someone enters the enclosed area encompassing the air cleaner and the ozone gas generator 406 is required to be deactivated, the control unit 402 can output the switch signal 415 to turn off the switch 421, and the feedback signal 414 can be the resistance of the resistor 422 multiplied by the current 413.

During the process when the ozone gas 406 is deactivated, the feedback signal 414 is increased when the switch 421 is turned on, because the current 413 does not change immediately at the moment the switch 421 is turned on and the resistance of the resistor 422 is larger than the resistance of the parallel connection of the resistors 422 and 423. Therefore, the inverter 408 can reduce the AC voltage 412 to reduce the current 413, thereby forcing the feedback signal 414 to return to its original voltage level and reduce the current of the ozone gas generator 406 to deactivate the generation of the ozone gas. It is noted that the voltage supplied to the ozone gas generator and the negative ion generator can be reduced by controlling the resistance of the feedback resistors. Accordingly, the ozone gas generator and the negative ion generator can share the same inverter. In one embodiment, the control unit 402 can be an MCU outputting an ON/OFF signal 411 to the pulse width modulator 416 to activate or deactivate the negative ion generator 404 and the ozone gas generator 406 at the same time.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An air cleaner, comprising:
a control unit configured to generate a control signal;
an inverter, coupled to the control unit, configured to generate a voltage according to the control signal;
a negative ion generator, coupled to the inverter, configured to receive the voltage to generate a negative ion; and
an ozone gas generator, coupled to the inverter, configured to receive the voltage to generate an ozone gas, wherein the negative ion generator and the ozone gas generator are both activated when the voltage is larger than a first voltage level, and the negative ion generator is activated and the ozone gas generator is deactivated when the voltage is less than the first voltage level and larger than a second voltage level.

2. The air cleaner as claimed in claim 1, wherein the ozone generator further generates a feedback signal and a sum of the control signal and the feedback signal has a predetermined voltage level.

3. The air cleaner as claimed in claim 2, wherein the inverter reduces the voltage to deactivate the ozone gas generator when the sum increases, and the inverter increases the voltage to activate the ozone gas generator when the sum decreases.

4. The air cleaner as claimed in claim 1, wherein the control signal is a first pulse width modulation (PWM) signal with a first duty cycle.

5. The air cleaner as claimed in claim 4, wherein a concentration of the ozone gas decreases with the increase of the first duty cycle, and the ozone gas generator is deactivated when the first duty cycle is less than a predetermined duty cycle.

6. The air cleaner as claimed in claim 4, wherein the inverter further generates a second PWM signal corresponding to the first PWM signal and generates the voltage according to the second PWM signal, the second PWM signal has a second duty cycle that increases with the decrease of the first duty cycle, and the frequency of the first PWM signal is less than that of the second PWM signal.

7. The air cleaner as claimed in claim 6, wherein the voltage is an alternative current (AC) voltage with an amplitude, and the amplitude increases with the increase of the second duty cycle.

8. The air cleaner as claimed in claim 1, wherein the inverter further comprises:
a pulse width modulator, coupled to the control unit and the ozone gas generator, configured to generate a driving signal according to the control signal;
a switch device, coupled to the pulse width modulator, a supply voltage, and a ground, configured to generate a pulse width modulation (PWM) signal; and
a transformer, having a primary side coupled to the switch device and a secondary side coupled to the negative ion generator and the ozone gas generator, configured to convert the PWM signal to the voltage.

9. The air cleaner as claimed in claim 1, wherein the control unit is a micro control unit (MCU).

10. The air cleaner as claimed in claim 1, further comprising:
a first resistor coupled to the ozone gas generator; and
a control circuit configured to receive a switch signal output by the control unit to generate a feedback signal, comprising:
a switch, coupled to the inverter and the ozone gas generator, configured to be turned on or off in correspondence to the switch signal; and
a second resistor coupled to the switch.

11. The air cleaner as claimed in claim 10, wherein the inverter increases the voltage when the switch is turned on, and the inverter decreases the voltage when the switch is turned off.

12. The air cleaner as claimed in claim 10, wherein the control signal is a direct current (DC) voltage, and a concentration of the ozone gas decreases with the increase of the DC voltage.

13. An air cleaner, comprising:
a control unit configured to generate a switch signal;
an inverter, coupled to the control unit, configured to receive a feedback signal with a predetermined voltage level to generate a voltage;
a negative ion generator, coupled to the inverter, configured to receive the voltage to generate a negative ion;
an ozone gas generator, coupled to the inverter, configured to receive the voltage to induce a current for generating an ozone gas; and
a control circuit, coupled to the control unit, the inverter, and the ozone gas generator, configured to receive the switch signal to generate the feedback signal, wherein the feedback signal is increased to reduce the voltage when the negative ion generator is to be activated and the ozone gas generator is to be deactivated, thereby enabling the feedback signal to return to the predetermined voltage level.

14. The air cleaner as claimed in claim 13, further comprising a first resistor coupled to the ozone gas generator, wherein the control circuit further comprises:
a switch, coupled to the inverter and the ozone gas generator, configured to receive the switch signal and be turned on or off in correspondence to the switch signal; and
a second resistor coupled to the switch.

15. The air cleaner as claimed in claim 14, wherein the switch is a transistor.

16. The air cleaner as claimed in claim 14, wherein the first resistor and the second resistor are parallel connected when the switch is turned on, and the second resistor is disconnected from the first resistor when the switch is turned off.

17. The air cleaner as claimed in claim 16, wherein the feedback signal is the current multiplied by a first resistance of the first resistor when the switch is turned off, and the feedback signal is the current multiplied by a second resistance of the parallel connection of the first and second resistors when the switch is turned on.

18. The air cleaner as claimed in claim 13, wherein the control unit further outputs a direct current (DC) voltage to the inverter to modulate a concentration of the ozone gas, and the concentration is decreased with the increase of the DC voltage.

19. The air cleaner as claimed in claim 13, wherein the inverter further comprises:
a pulse width modulator, coupled to the control unit and the control circuit, configured to output a driving signal corresponding to the feedback signal;
a switch device, coupled to the pulse width modulator, configured to output a pulse width modulation (PWM) signal corresponding to the driving signal; and
a transformer, having a primary side coupled to the switch device and a secondary side coupled to the ozone gas generator and the negative ion generator, configured to convert the PWM signal to the voltage, wherein the voltage is increased with the increase of a duty cycle of the PWM signal.

20. The air cleaner as claimed in claim 13, wherein the control unit is a micro control unit (MCU).
